(19) United States
(12) Patent Application Publication
(10) Pub. No.: US 2006/0013271 A1
(43) Pub. Date: Jan. 19, 2006

(54) Variable attenuator

(75) Inventor: Zheng-lin Wang, Carramar (AU)

Correspondence Address: MERCHANT & GOULD PC, P.O. BOX 2903, MINNEAPOLIS, MN, 55402-0903, US

(73) Assignee: Q-VIS LIMITED, Herdsman (AU)

(21) Appl. No.: 10/503,013

(22) PCT Filed: Jan. 31, 2003
(86) PCT No.: PCT/AU03/00104

§ 371 Date: Jul. 21, 2005

(30) Foreign Application Priority Data
Jan. 31, 2002 (AU) PS 0230

(51) Int. Cl. H01S 3/10

(52) U.S. Cl. 372/27

(57) ABSTRACT

Linearly polarised laser pulses are variable attenuated by rotating a plate (20) with respect to the optical axis (10). A second plate (21) may be arranged in a symmetrical manner to compensate for offset of the pulse from the optical axis (10). A feedback system may be used to control the orientation of the plates (20, 21) to achieve the desired intensity. The plates (20, 21) may comprise uncoated glass substrate, and are suitable for attenuating high energy pulses such as those used in eye surgery.

### FIELD OF THE INVENTION

The present invention is related to the control of laser parameters, in particular energy density or fluence.

### BACKGROUND ART

Different methods have been implemented to control the fluence of a laser system, but these methods generally include altering either pulse energy or beam diameter. One known approach is by way of a variable telescope configuration that varies the distance between a pair of lenses along the optical axis of the laser to alter the beam diameter. Another common method is to place a thin, coated optic in the path of the beam. Other attenuation and/or controlled output energy methods variously include the use of beamsplitters, linear optical absorbers, photochromatic absorbers and reflectors.

Polarisation characteristics have been utilised to control energy output in a number of laser applications. U.S. Pat. No. 5,383,199 describes an arrangement for optically controlling the output energy of an UV excimer laser angioplasty system. This arrangement involves placing an optically contacted thin film polariser, which is antireflection coated, in the path of the beam. A sensor is provided to detect the energy in the attenuated beam, and a controller is coupled to the sensor to control the rotation of the thin flim polariser to ultimately control the fluence of the system output beam.

A variable attenuator for a multi-wavelength Nd:YAG laser system is described in U.S. Pat. No. 5,703,713. The attenuator is composed of a multiple wavelength waveplate and a calcite polariser, and the angular position of both is varied to control the output energy. U.S. Pat. No. 4,398,806 describes the use of two wedge-shaped plates positioned in the path of the laser beam to polarise the incoming beam as a function of the angle of incidence. The angle of incidence is varied by rotating the plates. This system utilises Fresnel reflection near the critical angle at the second interface of the first wedge-shaped plate. The wedges are aligned in parallel, and preferably a second pair of wedges is placed in the beam path to achieve co-linearity of the output beam with the input beam.

U.S. Pat. No. 4,664,484 describes a variable attenuator comprising two spaced optical elements each with reflective surfaces. This attenuation system is based on reflection, whereby the incident radiation is reflected from the first window to the second, which has a metallised surface. These optical elements are moved relative to each other and rotated simultaneously around the optical axis to ensure the reflected beam is incident on the second surface at the same angle of incidence. The beam incident on the first surface is unpolarised and at least one of the elements is adapted to plane polarise the reflected beam. A second pair of reflective surfaces may be added to achieve co-linearity. Variable attenuators are also commonly used in optical fibre communications systems (see for example U.S. Pat. No. 6,149,278).

The use of the aforementioned methods in a high energy (ie. tens of millijoules per pulse or greater) pulsed solid state laser system is impractical because of the low damage thresholds of the optical components required to implement the respective optical configurations. Variable attenuators such as those described above that utilise coatings are also not feasible in a solid state based refractive surgery laser system, such as that described in international patent publication WO99/04317, as the reflectance of the coated optics are susceptible to changes in the angle of incidence. In these arrangements, a small change in the angle of incidence can result in very high losses, a situation that would not be suitable for a medical laser system. Dielectric mirrors (for high energy lasers) can have a small acceptance angle of <5° with a very sharp drop off in the reflectance outside this range, which also makes them unsuitable. The methods described above may also induce beam expansion resulting in a varying beam profile at the working plane. Varying beam sizes can result in changes to beam propagation and spatial beam profile.

### SUMMARY OF THE INVENTION

It is therefore an object of the invention to provide a method and apparatus for variably attenuating a light beam in a laser system that is suitable for incorporation in pulsed solid state laser systems of the kind used in medical applications such as refractive surgery.

It is a further object of the invention to provide a means to control laser fluence without affecting other parameters such as beam direction or spatial distribution to an unacceptable extent.

In a first aspect of the invention there is provided a method for variably controlling the energy output of a laser system including:
positioning in the path of a linearly polarised laser pulse of said laser system at least one optical element having a surface on which said pulse is incident and across which said pulse is at least partially transmitted;
rotating said optical element about an axis substantially parallel to, and preferably aligned with, said path to alter the polarisation of the laser pulse relative to the said surface thereby varying the energy of said transmitted pulse.

In the first aspect of the invention, there is further provided apparatus for variably controlling the energy output of a laser system, including:
a first optical element having a surface; and
means supporting said optical element for positioning thereof in the path of a linearly polarized laser pulse of said system so that said pulse is incident on said surface, and is at least partially transmitted across said surface;
wherein said supporting means is such that said optical element is rotatable about an axis substantially parallel to, and preferably aligned with, said path to alter the polarisation of the laser pulse relative to said surface thereby varying the energy of said transmitted pulse.

In a second aspect, the invention provides a method of variably controlling the energy output of a laser system, including:
positioning in the path of a linearly polarized laser pulse of said laser system at least one optical window element having parallel faces, on one of which said pulse is incident and across which the pulse is at least partially transmitted; and
rotating said optical window element to alter the polarization of the laser pulse relative to said faces, thereby varying the energy of said transmitted pulse.

In the second aspect, the invention further provides apparatus for variably controlling the energy output of a laser system, including:
an optical window element having a pair of parallel faces; and
means supporting said optical element for positioning thereof in the path of a linearly polarized laser pulse of said system so that said pulse is incident on at least one of such faces and is at least partially transmitted across said faces;

wherein said supporting means is such that said optical element is rotatable to alter the polarization of the laser pulse relative to said faces, thereby varying the energy of said transmitted pulse.

Preferably, in either or both aspects of the invention, the means supporting the optical element is a tubular member closed at one end by the optical element. Advantageously, there is a second optical element similar to the first closing the other end of the tubular member, the two elements being arranged to substantially eliminate offset of the laser pulse.

Said optical elements are preferably uncoated.

Means is preferably provided for monitoring the pulse energy downstream of the apparatus and for effecting said rotation in response to the monitored energy.

The invention is further directed to a laser system including means to generate a beam of laser pulses and incorporating one or both of said aspects of the invention.

In an advantageous application, the laser beam generating means is a solid state laser and the laser system includes means for generating, in a frequency conversion or harmonic generation process, a beam of predetermined wavelength from an output beam of said solid state laser of a wavelength different from the predetermined wavelength. The apparatus of the invention is preferably disposed to attenuate the laser beam between the solid state laser and the frequency conversion or harmonic generation means. There may typically be beam cross-section control means and/or scanning means downstream of the frequency conversion means.

In a particularly advantageous application, the laser system including the solid state laser comprises a laser surgical system for performing ophthalmic surgery such as corneal ablation, eg. for laser refractive correction surgery.

### BRIEF DESCRIPTION OF THE DRAWINGS

In order that the invention may be more fully understood, a preferred embodiment will now be described by way of example with reference to the following illustrations, in which:

FIG. 1 is a schematic optical diagram illustrating the underlying principle used in the invention;

FIGS. 2 and 3 are respective isometric views of a first embodiment of a variable attenuator according to the present invention;

FIG. 4 is an axial cross-section of the attenuator depicted in FIG. 3;

FIG. 5 is a schematic optical diagram of the configuration of a second embodiment of the present invention; and

FIG. 6 is a plot of experimental and theoretical transmittance against rotational angle for the variable attenuator of FIGS. 2 to 4; and

FIG. 7 is an optical diagram of a solid state laser ablation system incorporating a variable attenuator between the laser and the harmonic generation module of the system.

### PREFERRED EMBODIMENTS OF THE INVENTION

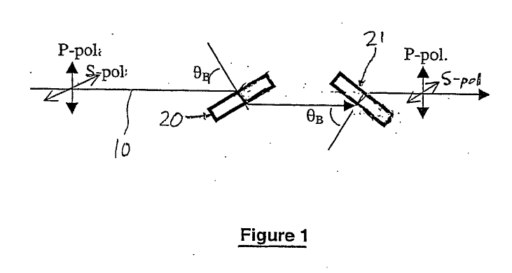

With reference to FIG. 1, the variable attenuator takes advantage of the polarisation of the incoming laser light 10. Two optical elements, eg in the form of windows 20, 21, are separated by a predetermined distance, which will depend on the amount of space in the delivery path of the laser system, but will preferably be as short as possible. Both windows 20, 21, are arranged with respect to the laser beam incident propagation path or axis 10 so that the angle of incidence of the laser beam is Brewster's angle θ_{B} (at which angle there is a zero reflection loss of P-polarised light). However, windows 20, 21 are oriented in a complementary and symmetrical manner so that their normals are coplanar but intersect (at an angle 180-2θ_{B}): this eliminates any offset between the incoming and outgoing beams. Another way of viewing this is to consider that the windows are at the same orientation to axis 10 but relatively rotated about an axis orthogonal to axis 10 by 180°.

When the windows are rotated about the axis of incident laser propagation 10, which is equivalent to a change of the relative incident polarization, the reflection loss of these windows will change from a minimum (P-polarized Brewster angle incidence) to a maximum (S-polarized Brewster angle incidence). The windows may be set with an angle of incidence outside of Brewster's angle to change the range of attenuation. The angle of incidence should be greater than approximately 15° for the reflection loss to significantly change. Reducing the range of attenuation will result in more precise variation in the output energy.

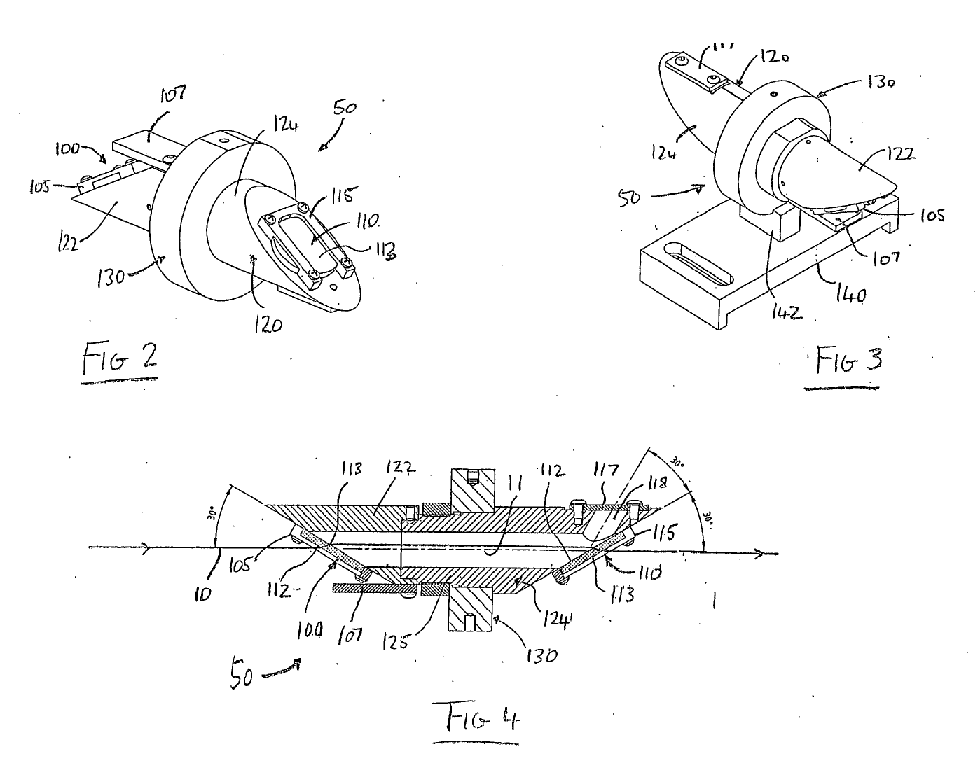

Referring to FIGS. 2 to 4, a first embodiment of attenuator 50 consists of a pair of spaced windows 100, 110 each having parallel faces 112, 113. Windows 100, 110 are located at and close to the respective ends of a closed tube 120. The tube 120 is constructed from aluminium or another suitable material and functions purely as a mount for the windows 100 & 110. Tube 120 is in two interlocking parts 122, 124, one including a centre region 125, and is held in a rotator bearing 130 by a nut 132. The assembly is held via a support block 142 engaging rotator bearing 130, on a standard optical mount (shown at 140 in FIG. 3 only). In this way, the device is positioned in the laser beam delivery path so that the axis 11 of the tube is co-incident with the laser beam propagation path 10, ie. the optic axis. The assembly may have more or fewer window elements inserted depending on the amount of attenuation variability required, but will most preferably have an even number of windows.

Windows 100, 110 are retained by screw-down clamp frames 105, 115 and are positioned with complementary and symmetrical orientations, as previously described, to avoid beam offset, with their normals in the same plane. The incident angles of the beam onto both windows 100, 110 is preferably also the same (in this case 60°, a little outside Brewster's angle) but with complementary orientations as mentioned above. Respective energy sink plates 107, 117 are provided to absorb light reflected at windows 100, 110. Plate 107 projects to the exterior at the input end, while plate 117 covers a laterally angled opening 118 at the other end.

Windows 100, 110 are preferably fashioned from uncoated glass pieces, as coated substrates suffer from low damage thresholds. Uncoated BK7 windows for 1064 nm have a good optical quality and a high damage threshold (>5 J/cm²), and are inexpensive and readily available. They are therefore most preferably utilised as windows 100, 110 in a 1064 nm Nd:YAG system.

The angular deviation of a beam after transmission through a window depends on its wedge angle, while the beam offset depends on the incident angle of the laser beam and the thickness of the window. Windows 100, 110 are chosen to have the same thickness and are placed symmetrically, so that their beam offsets will compensate for each other. Preferably, any window used in this arrangement should have as low as practical wedge angle.

For the reasons noted above, a change in the incidence angle of the incoming beam will result in a variation in the amount of laser energy transmitted through elements 100, 110. The output fluence of the laser system is therefore varied by synchronously rotating windows 100, 110 about the optical axis 10 of the incident laser beam. Rotator bearing 130 is used to set the rotation angle of windows 100, 110. Bearing 130 preferably has an angular tolerance of ±0.2° with a precise range of movement. The bearing may be rotated manually by hand (as for the illustrated arrangement of FIG. 2), or may be moved automatically via a motorised control system (eg. stepper motor/servo motor etc) in response to electrical control signals. In either case, worm gearing may be included in the drive. The motors are under computer control and a feedback system, such as that described in co-pending application PCT/AU01/01341, is initialised to determine the rotational requirements of bearing 130. An energy sensor (not shown) is located downstream of the attenuator assembly 50, and detects the energy levels of the harmonic beam. The computer controller determines an optimal target energy level and directs the motors to rotate windows 100, 110 in a predetermined direction to ensure the target energy is maintained. In this way, the overall fluence of the laser system is set, as the beam size remains constant. Alternatively, an open loop system, which uses tables from known values, may determine the angular position of windows 100, 110.

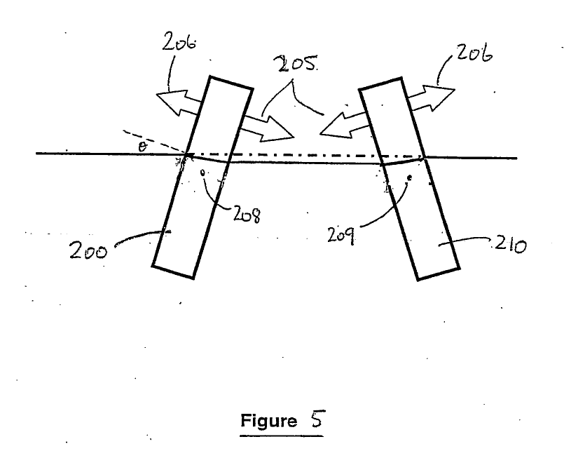

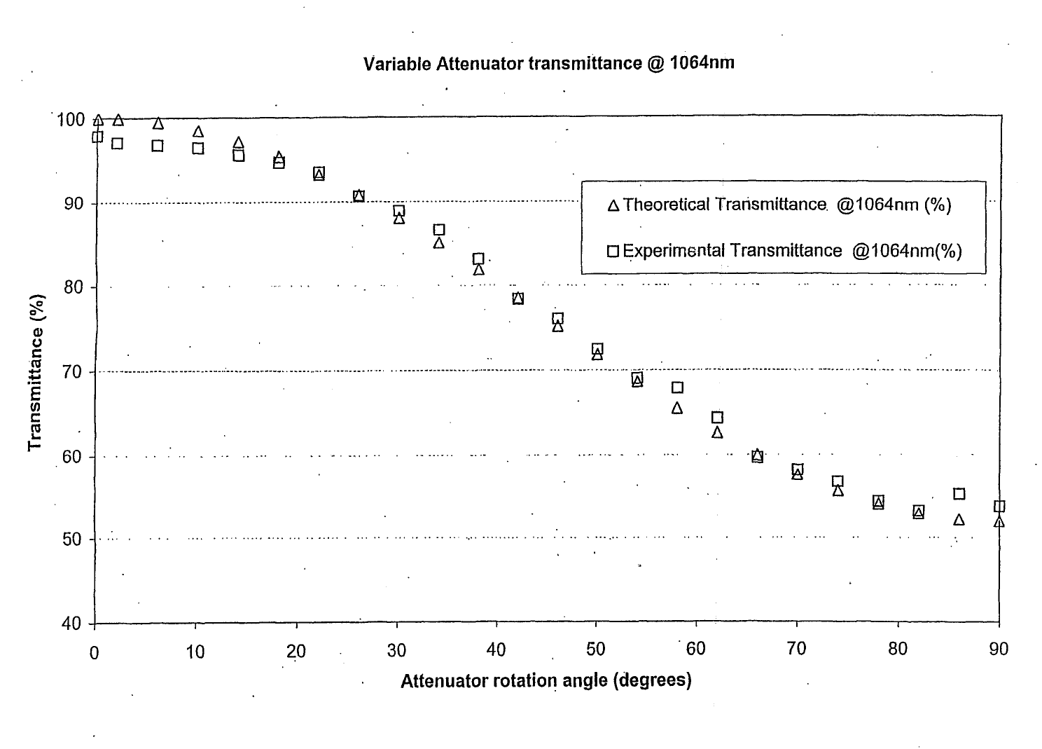

A second embodiment of the present invention involves adjusting the windows around the axis of beam polarisation, and is depicted purely schematically in FIG. 5. In this arrangement the windows 200, 210 are not rotated around the beam incident axis, but are instead adjusted about axes 208, 209 perpendicular to the beam axis, as represented by arrows 205, 206 in FIG. 5. The two elements 200, 210 are mechanically linked to rotate synchronously but oppositely and maintain beam offset: arrows 205 indicate rotation that increases the angle of incidence and arrows 206 indicate rotation to decrease the angle of incidence. Windows 200, 210 may be supported on either side by a mounting frame (not shown) with a gear system attached to the mount.

FIG. 6 is a plot of theoretical and experimental transmittances against rotational angle of variable attenuator 50. This example illustrates the attenuation range in a 1064 nm wavelength Nd:YAG laser system. As the attenuator angle increases the 1064 nm transmittance, and therefore output power decrease. Theoretically there is a maximum of 48% loss for the two windows. In practice this arrangement achieves from 5 to 50% loss. If more than 48% attenuation is required, then another two windows may be implemented into the attenuator assembly, the windows may be adjusted further away from Brewster's angle, or another attenuator assembly may be used.

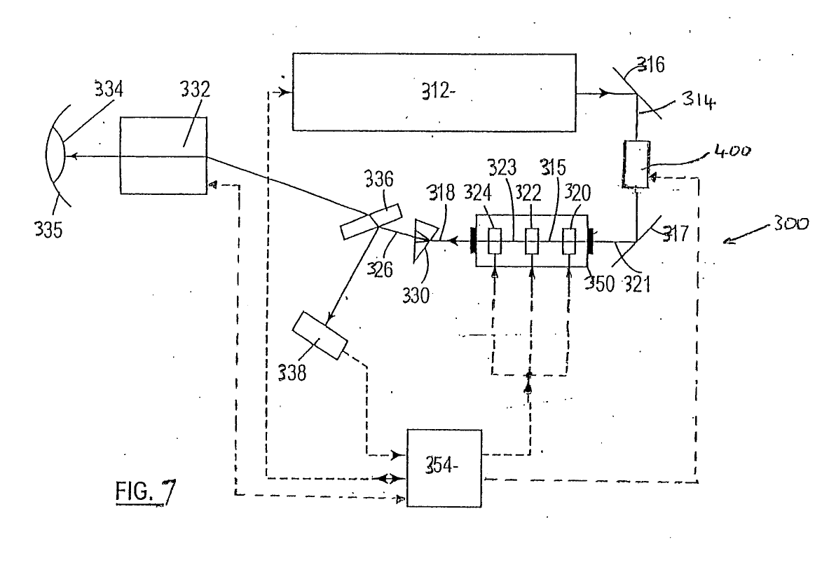

An advantage of the above described system is that it allows optimisation of the output of the fundamental laser in a solid state harmonic generation laser system. FIG. 7 is an optical diagram of an exemplary such system 300 configured for laser ablation, eg laser refractive correction ophthalmic surgery.

The system 300 includes a solid state laser 312 that emits a primary laser beam 314 in the infra-red region of the electromagnetic spectrum. Primary laser beam 314 is guided by optical elements, in this case mirrors 316, 317, along an optical alignment or axis 321, through a harmonic generation module 350 comprising a series of non-linear optical (NLO) crystals 320, 322, 324 from which emerges a multi-wavelength output beam 318. Beam 318 comprises the original beam 314 and several harmonics generated by crystals 320, 322, 324. The desired harmonic 326 is separated out by a prism 330. A dichroic mirror arrangement may alternatively be used for this purpose.

In an application for refractive eye surgery by photo-ablation, beam 326 is directed by a beam delivery system 332 onto the cornea 334 of an eye 335.

A small portion of component beam 326 is diverted by a beamsplitter 336 to a photo-detector 338 such as a photodiode for measuring and monitoring the energy of beam component 326.

Controller 354, typically a computer system, controls at least the output beam parameters of laser 312, and the elements of the beam delivery system.

A particularly suitable laser 312 is a Q-switched Neodymium:YAG laser producing a 2-10 mm diameter pulsed laser beam 314 of fundamental wavelength 1064 nm. The beam 314 is collimated, resulting in a collimated harmonically generated beam downstream. A variety of other laser sources are suitable but preferred sources are Nd³⁺ doped laser media such as Nd:YLF, Nd:glass and Nd:YV0₄.

A particularly convenient crystal set 320, 322, 324 is as disclosed in international patent publication WO 99/04317. In this configuration, crystal 320 is a BBO crystal that uses type I or type II phase matching as a frequency doubling unit to generate a frequency doubled beam 315 of second harmonic wavelength 532 nm. Instead of a BBO crystal 320 may alternatively be a KTP, LBO, KD*P or any other suitable NLO crystal. The other two crystals 322, 324 are preferably CLBO crystals although other suitable crystals include BBO, and KD*P and related isomorphs. Crystal 322 converts frequency doubled beam 315 at 532 nm to a beam 323 of 4th harmonic wavelength 266 nm, utilising type I phase matching. In crystal 324, beam components 315 and 323, of fundamental and fourth harmonic wavelengths respectively, are frequency mixed to produce a laser beam component 326 of the fifth harmonic wavelength, 213 nm. This is effected by means of sum frequency generation, a type I phase matching interaction.

Further details of this process and of the crystals themselves are to be found in the aforementioned international patent publication, the disclosure of which is incorporated herein by reference.

Advantageously, a variable attenuator 400 similar to attenuator 50 of FIGS. 2 to 4 above is disposed in the laser beam path 314 between laser 312 and harmonic generation module 350, and the setting of attenuator 400 is determined by controller 354 in response to inputs that include the monitored energy at photodectector 338. The result is a change in the input energy of the fundamental wavelength pulsed laser beam eg a 1064 nm beam for an Nd:YAG laser, and resultant control of the output fluence of the harmonically generated beam. This configuration is contrary to current practice in most solid state and refractive laser settings, where the fluence control optics are usually placed at the end of the delivery system.

Alternatively, the attenuator may be placed in the path of any of the polarised harmonic beams, as its function is dependent on the polarisation of the beam and not the wavelength. In particular, it may be advantageous to position attenuator 400 downstream of harmonic generation module 350, preferably prior to prism 330.

It will be appreciated that, in the configuration of FIG. 7, the laser output is optimised in a manner that is easy to implement, and inexpensive. The configuration minimises impact on beam divergence or convergence in contrast to the effect of variable telescopes. High energy is applied only at the beginning of the delivery system, with resultant reduced damage to downstream optics, particularly in the UV range.

In an advantageous modification of laser system 300, suitable optics such as one or more mirrors are placed downstream of module 350 to filter a high proportion of the non-selected harmonics, eg. other than the 213 nm fifth harmonic in the example under consideration, and so reduce the thermal energy load on the prism 330 and extend its effective life. In this configuration, attenuator 400 may be disposed between the absorbing optics at the prism.

In a further modification, there may be two variable attenuators in series, a manually adjusted device for course setting and a motor-driven device for fine adjustment.

The variable attenuator could of course also be applied to any other laser system that utilises polarised light.

Modification within the spirit and scope of the invention may be readily effected by a person skilled in the art. Thus, it is to be understood that this invention is not limited to the particular embodiments described by way of example herein above.

1. A laser system including:
a solid state laser for generating an output beam of linearly polarized laser pulses; means for generating from said output beam, in a frequency conversion or harmonic generation process, a further beam of linearly polarized laser pulses of predetermined wavelength which predetermined wavelength is different from the wavelength of said output beam;
a first optical element having a surface; and
means supporting said optical element in the path of at least one of said beams so that the respective said pulses of the beam are incident on said surface, and are at least partially transmitted across said surface,
said optical element being rotatable about an axis substantially parallel to said path to alter the polarisation of the incident laser pulses relative to said surface thereby varying the energy of said transmitted pulses; and
a second rotatable optical element and supporting means therefor similar to the first, the two elements being co-operatively arranged to substantially eliminate offset of said at least one beam.

2. A laser system according to claim 1 wherein said axis is aligned with said path.

3. A laser system according to claim 1 wherein said means supporting the first optical element is a tubular member closed at one end by the optical element and rotatable about its longitudinal axis to effect rotation of said first optical element.

4. A laser system according to claim 3 wherein said second optical element closes another end of said tubular member.

5. A laser system according to claim 1 wherein said optical elements are uncoated.

6. A laser system according to claim 1, further including manually operable means for effecting said rotation.

7. A laser system according to claim 1, further including means responsive to electrical control signals for effecting said rotation.

8. A laser system according to claim 1, further including means for monitoring the pulse energy downstream of the apparatus, and means for effecting said rotation in response to the monitored energy.

9. (canceled)

10. (canceled)

11. A laser system according to claim 1, wherein said apparatus is disposed to attenuate the laser beam between the solid state laser and the frequency conversion or harmonic generation means.

12. A laser system according to claim 1 further including prism means for separating output beams of said process, and wherein said apparatus is disposed to attenuate the laser beam between said frequency conversion or harmonic generation means and the prism means.

13. A laser system according to claim 1, further including beam cross-section control means downstream of the frequency conversion or harmonic generation means.

14. A laser system according to claim 1 including beam scanning means downstream of the frequency conversion or harmonic generation means.

15. A laser system according to claim 1 wherein the laser system including the solid state laser comprises a laser surgical system for performing ophthalmic surgery such as corneal ablation, eg. for laser refractive correction surgery.

16. (canceled)

17. (canceled)

18. (canceled)

19. Apparatus for variably controlling the energy output of a laser system, including:
an optical window element having a pair of parallel faces; and
means supporting said optical element for positioning thereof in the path of a linearly polarized laser pulse of said system so that said pulse is incident on at least one of such faces and is at least partially transmitted across said faces;
wherein said supporting means is such that said optical element is rotatable to alter the polarization of the laser pulse relative to said faces, thereby varying the energy of said transmitted pulse.

20. Apparatus according to claim 19 wherein said optical elements are uncoated.

21. Apparatus according to claim 19 further including manually operable means for effecting said rotation.

22. Apparatus according to claim 19, further including means responsive to electrical control signals for effecting said rotation.

23. Apparatus according to claim 19, further including means for monitoring the pulse energy downstream of the apparatus and for effecting said rotation in response to the monitored energy.

24. A laser system including means to generate a beam of laser pulses and incorporating apparatus according to claim 19 for controlling the energy output of the system.

25. A laser system according to claim 24 wherein said laser beam generating means is a solid state laser and the laser system includes means for generating, in a frequency conversion or harmonic generation process, a beam of predetermined wavelength from an output beam of said solid state laser of a wavelength different from the predetermined wavelength.

26. A laser system according to claim 25, wherein said apparatus is disposed to attenuate the laser beam between the solid state laser and the frequency conversion or harmonic generation means.

27. A laser system according to claim 25 further including prism means for separating output beams of said process, and wherein said apparatus is disposed to attenuate the laser beam between said frequency conversion or harmonic generation means and the prism means.

28. A laser system according to claim 25 further including beam cross-section control means downstream of the frequency conversion or harmonic generation means.

29. A laser system according to claim 25 further including beam scanning means downstream of the frequency conversion or harmonic generation means.

30. A laser system according claim 24, wherein the laser system including the solid state laser comprises a laser surgical system for performing ophthalmic surgery such as corneal ablation, eg. for laser refractive correction surgery.

31. A method of variably controlling the energy output of a laser system, including:
positioning in the path of a linearly polarized laser pulse of said laser system at least one optical window element having parallel faces, on one of which said pulse is incident and across which the pulse is at least partially transmitted; and
rotating said optical window element to alter the polarization of the laser pulse relative to said faces, thereby varying the energy of said transmitted pulse.

32. A method according to claim 31 further including monitoring the downstream pulse energy and effecting said rotation in response to the monitored energy.
